(19) United States
(12) Patent Application Publication
(10) Pub. No.: US 2016/0244240 A1
(43) Pub. Date: Aug. 25, 2016

(54) Holder for a Cup with an Associated Game

(71) Applicant: Pollard Banknote Limited, Winnipeg (CA)

(72) Inventors: Mike Brickwood, Winnipeg (CA); Valerie M. Friesen, Winnipeg (CA); Craig Kohn, Council Bluffs, IA (US); Linda Harte-Maxwell, Council Bluffs, IA (US); Nancy Bettcher, Winnipeg (CA)

(21) Appl. No.: 15/010,255

(22) Filed: Jan. 29, 2016

Related U.S. Application Data
(60) Provisional application No. 62/113,719, filed on Feb. 9, 2015.

(51) Int. Cl. B65D 81/38; B42D 15/00

(52) U.S. Cl. CPC B65D 81/3876; B42D 15/00

(57) ABSTRACT

A holder for a disposable beverage cup has an associated game and is formed by a band of a substrate material such as card-board in frusto-conical shape when expanded to surround a wall of the cup. Printed game data on the substrate material provides access to symbols of a lottery game to be played by a player either by removing a covering or by accessing a web site using a printed code. Preferably the symbols of the lottery game are applied onto a front flat panel of the substrate and there is provided a covering material which is either a window or scratch-off material over the game data which hides the game data and is spaced from side edges of the flat front panel.

This application claims the benefit under 35 USC 119 (e) of Provisional application 62/113719 filed Feb. 9, 2015.

This invention relates to a holder for a cup with an associated game.

### BACKGROUND OF THE INVENTION

Game or lottery tickets which include a scratch-off layer covering game indicia which can be exposed by the player removing the layer for playing of the game or lottery are well known and widely sold.

The game provided may be for prizes both monetary and product related or may be merely for entertainment where no gambling or prize is involved. The type and value of any prizes can vary widely. The games may be predetermined, otherwise known as “instant win” tickets or may include elements of skill or chance.

The games concerned are in many cases instant win type games where the result is entirely predetermined, since such games are generally preferred in a lottery situation in order to ensure that the total winnings is predetermined. However the present invention is not limited to the type of game to be played and can include probability or other games which include game indicia covered by a scratch-off coating.

The construction may also be used in situations where the main objective is for other purposes than gambling such as in promotional games or games of fun for children or others where no gambling or prizes are involved.

Many such tickets are used directly in a lottery situation so that the tickets have no other relevance other than the playing of the lottery or game by which the player may win monetary or other prizes as part of the lottery or gaming situation. However attention has been recently given to other uses of such tickets such as promotional items used by manufacturers of other products to enhance the sale of the product, or as part of packaging or in other situations where the substrate acts in another capacity and the lottery ticket aspect is merely one part of its function.

The marketing of lottery tickets is primarily based on the psychology of impulse buying so that the ticket itself must be inherently attractive to the potential customer sufficiently to trigger the sale. Particular attention is therefore applied to generating attractive graphics and an attractive appearance of the game face of the ticket.

For this reason high quality graphics and full four colour printing are used in the printing of the product. This is of particular importance in the area at the game data. Tickets of this type primarily utilize scratch-off technology for covering the game data and techniques for applying the scratch-off coating in a manner which provides the necessary protection and security for the game data have become well established. On top of the scratch-off coating it is common to print additional graphics, often in four colour printing for the purposes of providing the required attractive appearance of the ticket.

Up to now such games or lottery tickets have primarily been sold thorough a specific lottery ticket retailer as a dedicated ticket bought only for the purpose of the game

### SUMMARY OF THE INVENTION

It is one object of the invention to provide a holder for a cup with an associated game.

According to one aspect of the invention there is provided a holder for a cup with an associated game playable by a player comprising:

a band of a substrate material shaped and arranged to surround a wall of the cup so that the cup can be carried by the player using the holder;

printed game data carried on the substrate material, the game data being arranged to provide access to symbols of a game to be played by a player;

and printed game information carried on the substrate material, the game information being arranged to provide information for the player relating to the game.

In one arrangement the printed game data is arranged to provide access to the game symbols which are located at a web site accessible by the player. In this case the game data can comprises a machine readable image or a QR code which can be read by a hand held device and acts to link the hand held device to a web site for play by the player.

Preferably the web site provides communication through the Internet to that site. However the present invention contemplates other forms of communication and that the site has characteristics suitable for that mode of communication. There may be provided additional games to be played on the web site such as on line instant games.

In the preferred embodiment the symbols of the game to be played by a player are carried by the substrate allowing play of the game at the site of the holder or later. The symbols are applied by printing to the substrate or more typically to a protective under-layer such as a lily-pad and there is provided a covering material over the game data which hides the game data and is arranged to allow the covering to be removed.

Preferably the symbols are covered by one or more break-open windows. In this case the substrate is defined by two layers with a top one of the layers defining a break-open window and a bottom one of the layers having the symbols thereon. Alternatively the symbols could appear inside, on either the bottom layer or the reverse side of the window(s).

As an alternative the covering material comprises a layer of a scratch-off material.

As a further alternative the covering material comprises a layer of a scratch-off material under a break open window.

Preferably the substrate material is selected so as to allow the game data to be printed onto the substrate itself, including any covering layers which form part of the substrate. However as an alternative, for example where the substrate is of a material which does not allow this, the game data can be printed onto a label, including any covering layers which form part of the label, and the label then applied onto the substrate using an adhesive or other attachment method. In this way the game data is carried by the substrate but not directly applied to the substrate.

In order to surround a typical disposable cup, the band is preferably frusto-conical, at least when expanded for use. Thus typically the band has ends which are overlapped and connected preferably by adhesive but also possibly with 2-sided tape, staples or rivets. When supplied in flat form, as preferred, the band is folded flat to form a flat front panel and a flat rear panel. However alternatively the band may be supplied as a flat band with unconnected ends which can be looped together, at a place of use, in known manner with hook elements at the ends.

Preferably when supplied in flat folded form, the game information is printed only on the front panel at positions spaced from side edges of the front panel with the game data printed on the rear panel or on a reverse side of the front panel.

In order to form the required frusto-conical shape when expanded, preferably each of the front and rear panels has an arched top and bottom edge so that when expanded into the frusto-conical form to match the cup, the top and bottom edges lie in a radial plane of the cup. However the game data is preferably printed in straight lines across the front or rear panel as a rectangular area spaced from side edges of the panel and from the top and bottom edges.

The games concerned are preferably instant win type games where the result is predetermined, since such games are generally preferred in a lottery situation in order to ensure that the total winnings is predetermined. In a situation where the game is merely for entertainment, the instant win game of course gives the player the required instantaneous entertainment value. However the present invention is not limited to the type of game to be played and can include probability or other games which include game indicia covered by a scratch-off coating.

The construction may also be used in situations where the main objective is for other purposes than gambling such as in promotional games or games of fun for children or others where no gambling or prizes are involved such as tickets used as promotional items by manufacturers of other products to enhance the sale of a product or simply to promote the company concerned.

Preferably the game data on each ticket defines an instant win game revealing whether the player is a loser or a winner of a prize and if so the value of that prize. Preferably the covering is a scratch-off layer typical with instant win tickets but it can be provided by other types of removable covering. Also the game can be other types of games such as a simple draw, a game of no prize value or even probability type games where the result is determined by the actions of the player.

In a preferred arrangement, the apparatus for playing the game comprises a set of the tickets printed on a series of the cup holders, the set of tickets each comprising the substrate having printed thereon, in one or more areas, game data covered by one or more areas of scratch-off coating or one or more pull-tab windows or a combination of both pull-tab windows with scratch-off beneath, which can be opened or removed by the player to expose the game data. As set out above, typically the exposed game data includes an instant win game revealing whether the player is a winner of a prize and if so the value of that prize.

Each cup holder may include an optional validation number for use in validating a prize when required. In some cases there may be provided a data base containing a look-up-table including the validation numbers in association with a prize of the first game. In some cases the data base for validation is accessible from lottery retailers for determining the prize and is accessible for determining the prize. In other cases the game on the cup holder can simply be validated by sight validation where the prizes are low.

Basically, where the game is a lottery game, an instant win scratchoff game is generated conventionally with a fixed, instant prize structure. The tickets defined by the cup holders may be then sold to a lottery organization who market the tickets to places of use of the cup holders such as restaurants or drinks retailers. Players obtain the cup holders at the use location and play proceeds as normal. If the ticket is an apparent winner the player can redeem the ticket typically at the use location or at a lottery retailer. If required, at the time of redemption the winning status of the tickets can be verified prior to payment. When redeemed, use location or the lottery or a lottery retailer can pay the player for the prize shown on the ticket. As an alternative to the sales being arranged wholly through a lottery, some possible prizing may be provided by the use location themselves, for example free coffee, and may not necessarily be funded or paid by the lottery.

According to another alternative aspect of the invention there is provided a cup for a beverage where the printed game data are carried on the material of the cup, the game data being arranged to provide access to symbols of a game to be played by a player and the printed game information is also carried on the material of the cup, the game information being arranged to provide information for the player relating to the game. The game data and the game information can be printed onto the material of the cup, or on underlying layers on the material or can be printed onto a label which is attached to the cup by adhesive or by other fastening means.

### BRIEF DESCRIPTION OF THE DRAWINGS

One embodiment of the invention will now be described in conjunction with the accompanying drawings in which:

FIG. 1 is a plan view of a cup holder and lottery ticket game according to the present invention showing an unconnected and unfolded blank prior to connection.

FIG. 2 is a plan view of the cup holder of FIG. 1 showing the folded condition with the front panel exposed.

FIG. 3 is a plan view of the front panel of a further embodiment according to the present invention.

FIG. 4 is a plan view of the front panel of a yet further embodiment according to the present invention.

FIG. 5 is a schematic illustration of a further embodiment according to the present invention.

In the drawings like characters of reference indicate corresponding parts in the different figures.

### DETAILED DESCRIPTION

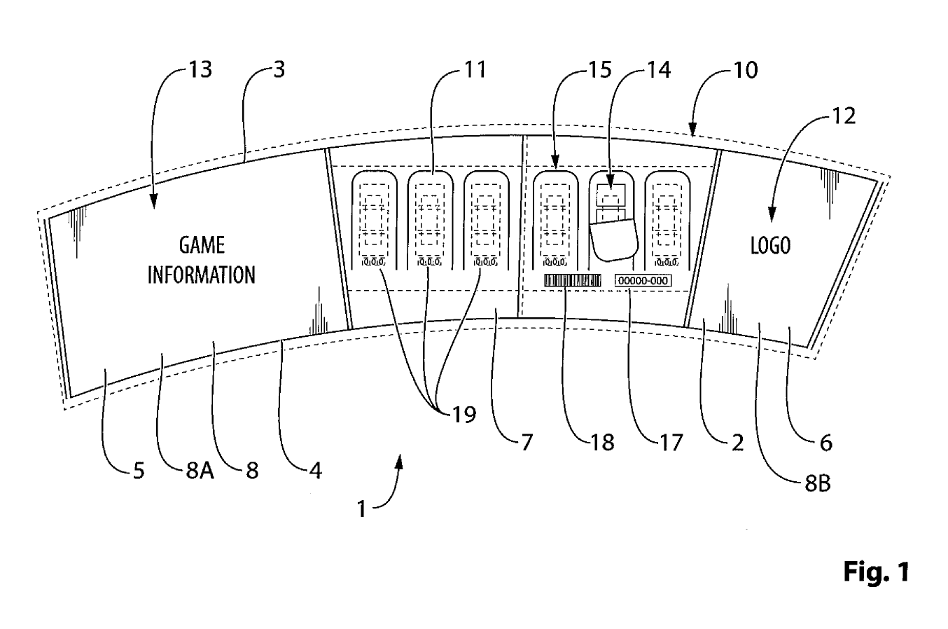

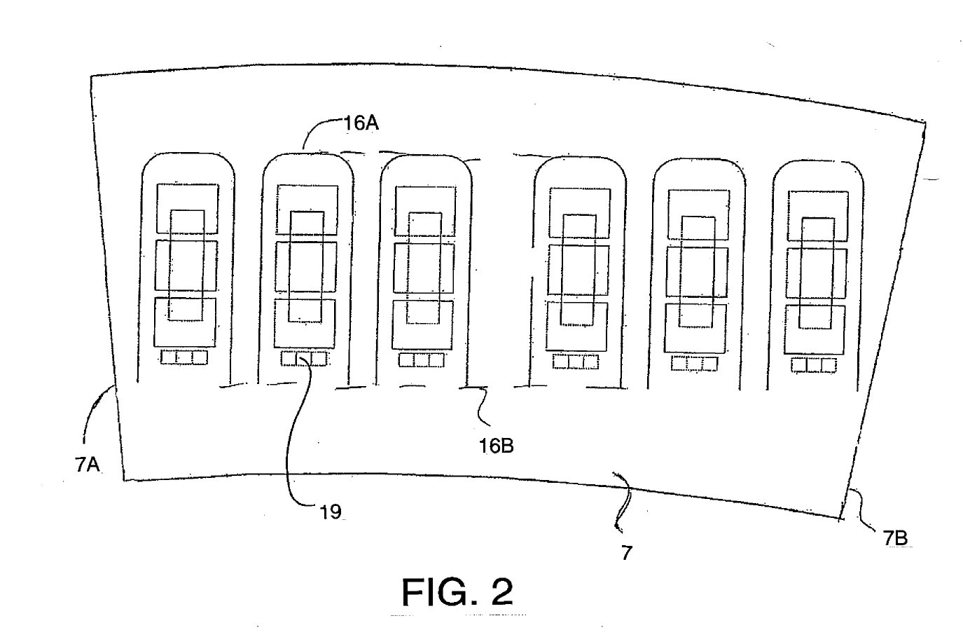

The apparatus shown in FIGS. 1 and 2 comprises a cup holder 1 having a game 2 printed thereon, for use in a game to be played by a plurality of players, includes a set of cup holders forming the game tickets.

The set of tickets includes a plurality of individual tickets where the number of tickets can vary but typically the tickets are formed in sets for a particular game.

Each cup holder 1 defines a single ticket of the game which is formed of a substrate 10 having printed thereon, either directly or more typically on underlying coating layers, various information necessary for the game to be played. This includes a game logo 12 and game information or rules 13 which set out the basis by which the winning and losing status of the ticket is instantly determined from the game data 14 including a level of prize for a winning ticket. Many different arrangements for such instant win tickets are well known to a person skilled in the art.

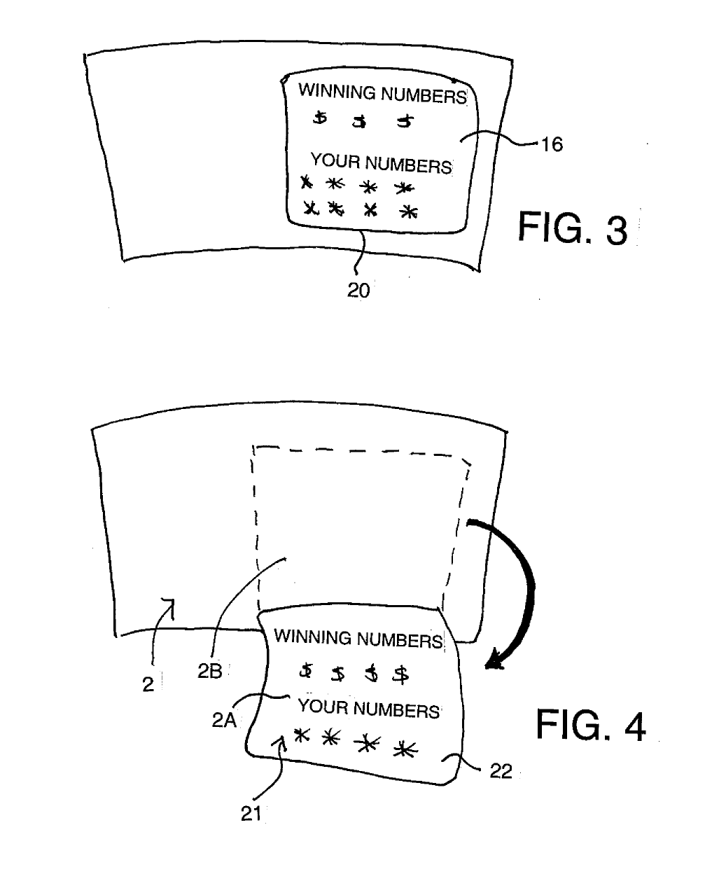

The game data 14 is printed in a game area 15 using printing techniques well known to a person skilled in the art and is covered by a covering layer which can be a break-open window 11 or can be a scratch-off layer 16 as shown in FIG. 3.

The ticket or sleeve forming the cup holder may include a validation number 17 and a bar code 18 related to the validation number allowing these to be used to validate any prize claimed by a player after playing the game by exposing the game data. However the sleeves may not include a validation number and may just rely on sight validation codes 19 provided at each window 11. If there is no validation number then validation may be carried out by the use of agent codes as an alternative or by any other method which indicates the winning status and the winning amount.

The bar code and validation number, or other status indicator, can be left exposed or be covered before playing. In a scratch-off ticket, the validation number can be covered for example by a separate area of scratch-off or by the same area of scratch-off. If the barcode and validation number are exposed on the un-played ticket then the validation number typically is incomplete. To ensure security, some of the digits from the validation number can be hidden from view under scratch-off. If a barcode is hidden then it can contain all of the necessary data to complete the validation process. On tickets with a break-open window or windows, the validation number can be provided underneath the window or may be exposed.

The game data 14 is thus covered by a covering which can be removed by a player to expose the game data with the exposed game data including an instant win game revealing whether the player is a winner of a prize and if so the value of that prize.

The cup holder 1 thus is defined by a band 2 of a substrate material 10 shaped and arranged to surround a wall of the cup. Thus the band forms an arch with a top edge 3 and a bottom edge 4 defining arcs so that when an overlap area 5 at one end is glued to the underside of an end portion 6 at the other end the arc can be expanded into a frusto-conical shape to surround the wall of a conventional disposable cup for coffee or other drink hot or cold.

The band is thus frusto-conical when expanded to the circular condition into a frusto-conical shape the top and bottom edges 3, 4 are circular in the expanded condition. The band when folded flat as shown in FIG. 2 provides front and rear panels each of which has an arched top and bottom edge.

The substrate can be formed of any suitable material which resists heat transfer such as card-board. Other materials such as foam or corrugated board can be used. The preferred arrangement uses simply a board material so that the printing of the game data can be applied directly. However another arrangement uses a label or patch 20 as shown in FIG. 3 where the printing is applied to the label which is then bonded to the front panel 7 or could be directly applied to the cup.

The area 16 contains the printed game data on the substrate material arranged to provide access to symbols of a lottery game to be played by a player.

The rear panel 8 defined by overlapped portions 8A and 8B carries the game information 13 and logo 12. However this is an example only and the logo and game information and game indicia can appear elsewhere, and not restricted to these specific locations.

In FIGS. 1 to 4, the symbols of the game to be played by a player are applied onto the substrate and there is provided a covering material defined by the break-open window or the scratch-off over the game data which hides the game data and is arranged to allow the covering to be removed.

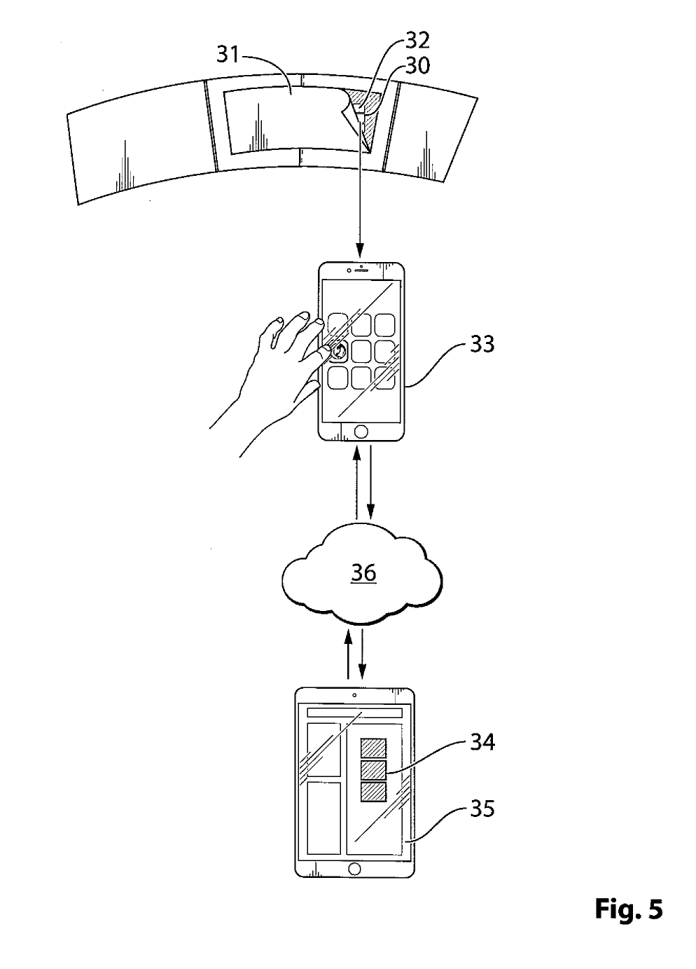

In FIGS. 1 and 2 the symbols are covered by one or more break-open windows. In this case the substrate is defined by two layers 2A and 2B as shown in FIG. 4 with a top one of the layers 2A defining one or more break-open windows and a bottom one 2B of the layers having the symbols thereon. The game data can alternatively be located on the layer 2A.

As shown also in FIG. 4 the covering material comprises a layer of a scratch-off material 21 accessible by opening a break open window 22 where the game indicia is provided on the rear face of the removable window 22, not the sleeve itself.

As shown in FIG. 2, the band is folded flat to form a flat front panel 7 and a flat rear panel behind which is not visible. The game data is printed only on front panel so that the game information is printed on the rear panel. The front and rear panels 7, 8 are connected at edges 7A, 7B thereof along perforated or scored fold lines. While the top and bottom edges 3, 4 are arched, the game data is printed in straight lines across the front panel 7 as a rectangular area with top and bottom edges 16A and 16B. This presents the data to the reader in a flat plane area particularly when the structure is in the flat condition shown in FIG. 2. This enables the game data and the break-open window or windows or the scratch-off material to be located in the game data area 16 spaced from side edges 7A, 7B of front panel 7. In this way the fold lines do not in any way interfere with or damage the covering material.

In FIG. 5 is shown an alternative arrangement in which the printed game data 30 is optionally covered by a window 31 which allows the player to access the game data. Game data could alternatively be located on the reverse side of the window 31. In any case the game data may not provide the game details and symbols related thereto but instead provides a code 32 which is readable by the player visually to be entered manually into a smart phone 33 or other machine readable image which is directly readable by the smart phone 33, such as a scanned QR code. When entered, the game data is arranged to provide access to the game symbols 34 which are located at a web site 35 accessible by the player through the internet 36.

1. A holder for a cup with an associated game playable by a player comprising:
a band of a substrate material shaped and arranged to surround a wall of the cup so that the cup can be carried by the player using the holder;
printed game data carried on the substrate material, the game data being arranged to provide access to symbols of a game to be played by a player;
and printed game information carried on the substrate material, the game information being arranged to provide information for the player relating to the game.

2. The cup holder according to claim 1 wherein the printed game data is arranged to provide access to the game symbols which are located at a web site accessible by the player.

3. The cup holder according to claim 1 wherein the symbols of the lottery game to be played by a player are applied onto the substrate and there is provided a covering material over the game data which hides the game data and is arranged to allow the covering to be removed.

4. The cup holder according to claim 3 where in the symbols are covered by one or more break-open windows.

5. The cup holder according to claim 4 wherein the substrate is defined by two layers with a top one of the layers defining a break-open window and a bottom one of the layers or the back side of the top layer having the symbols thereon.

6. The cup holder according to claim 1 wherein the covering material comprises a layer of a scratch-off material.

7. The cup holder according to claim 1 wherein the covering material comprises a layer of a scratch-off material under a break open window.

8. The cup holder according to claim 1 wherein the game data is carried on the substrate.

9. The cup holder according to claim 1 wherein the game data is carried on a label applied on the substrate.

10. The cup holder according to claim 1 wherein the band is frusto-conical.

11. The cup holder according to claim 1 wherein the band has ends which are overlapped and connected.

12. The cup holder according to claim 1 wherein the band is folded flat to form a flat front panel and a flat rear panel.

13. The cup holder according to claim 12 wherein the game data printed only on the front panel.

14. The cup holder according to claim 12 wherein the game information is printed on the rear panel.

15. The cup holder according to claim 12 wherein the front and rear panels are connected at edges thereof along perforated or scored fold lines.

16. The cup holder according to claim 12 wherein each of the front and rear panels has an arched top and bottom edge so that when expanded into a frusto-conical shape the top and bottom edges are circular.

17. The cup holder according to claim 16 wherein the game data is printed in straight lines across the front panel.

18. The cup holder according to claim 16 wherein the game data spaced from side edges of front panel.
